(19) United States
(12) Patent Application Publication
(10) Pub. No.: US 2014/0090429 A1
(43) Pub. Date: Apr. 3, 2014

(54) CYLINDER LOCK, ELECTRONIC DEVICE, AND CASH REGISTER

(71) Applicant: FUNAI ELECTRIC CO., LTD., Osaka (JP)

(72) Inventors: Daisuke TAKASAKA, Osaka (JP); Ryuuji AOKI, Osaka (JP)

(73) Assignee: FUNAI ELECTRIC CO., LTD., Osaka (JP)

(21) Appl. No.: 14/034,628

(22) Filed: Sep. 24, 2013

(30) Foreign Application Priority Data
Oct. 3, 2012 (JP) 2012-221542

(51) Int. Cl. E05B 27/00

(52) U.S. Cl. CPC E05B 27/00
USPC 70/490

(57) ABSTRACT

A cylinder lock includes: an outer shell provided with a cylindrical hollow portion therein; a rotatable plug rotatably positioned in the hollow portion of the outer shell and provided with a keyway along a rotational axis of the rotatable plug for accommodating a key; a rotation arresting member which arrests rotation of the rotatable plug by projecting out from the rotatable plug into a pathway provided in the outer shell; a biasing member which biases the rotation arresting member in a projecting direction thereof from the rotatable plug; and a beveled edge provided at an end of the rotation arresting member and having a beveled surface intersecting a rotational direction of the rotatable plug. Insertion of the key into the keyway causes the beveled edge to move from the outer shell toward the rotatable plug to a position intersecting an inner circumference of the outer shell.

### CROSS REFERENCE TO RELATED APPLICATION

The present application is based on and claims priority of Japanese Patent Application No. 2012-221542 filed on Oct. 3, 2012. The entire disclosure of the above-identified application, including the specification, drawings and claims is incorporated herein by reference in its entirety.

### FIELD

The present invention relates to cylinder locks and is applicable in particular to cylinder locks for desk drawers and cabinets, lockers, and electronic devices such as cash registers.

### BACKGROUND

Electronic devices such as cash registers, which are used to perform calculations related to currency as well as to store, deposit, and withdrawal cash, are equipped with a mechanical cylinder lock on the drawer so the withdrawal of cash is possible even in the event of a loss of power. Some such cylinder locks are provided with a click mechanism (detent mechanism) which, upon rotation of the key, provides tactile and audible feedback with a click sensation (the sensation a detent provides) to notify of a given rotational position of the key.

Patent Literature 1 (PTL 1), for example, discloses a click mechanism which generates a click sensation. According to PTL 1, since assembly by hand is difficult when the click mechanism is small, assembly of the cylinder lock is made easier by enlarging the size of the click mechanism as much as possible.

### CITATION LIST

### Patent Literature

[PTL 1] Japanese Unexamined Utility Model (Registration) Application Publication No. H6-74767

### SUMMARY

### Technical Problem

However, there is a demand for cylinder locks used in electronic devices such as cash registers to be small and have as few parts as possible while being capable of generating a click sensation.

The present invention has been made in view of the above problem, and aims to provide a cylinder lock that has few parts and is capable of being miniaturized in addition to being capable of generating a click sensation when a key is turned.

### Solution to Problem

In order to achieve the objectives described above, the cylinder lock according to the present invention includes: an outer shell provided with a cylindrical hollow portion therein; a rotatable plug rotatably positioned in the hollow portion of the outer shell and provided with a keyway along a rotational axis of the rotatable plug, the keyway being for accommodating a key; a rotation arresting member which arrests rotation of the rotatable plug by projecting out from the rotatable plug and entering a pathway provided in the outer shell; a biasing member which biases the rotation arresting member in a direction in which the rotation arresting member projects out from the rotatable plug; and a beveled edge provided at an end of the rotation arresting member and having a beveled surface which intersects a rotational direction of the rotatable plug, wherein insertion of the key into the keyway causes the beveled edge, along with the rotation arresting member, to move in a direction from the outer shell toward the rotatable plug to a position at which the beveled edge and an inner circumference of the outer shell intersect.

Providing a beveled edge at an end of the rotation arresting member which arrests rotation of the rotatable plug enables the rotation arresting member with the key inserted therein to function as a part of the click mechanism. This makes it possible to eliminate the need to provide a separate click mechanism, reduce the number of parts of the cylinder lock, and contribute to the miniaturization of the cylinder lock.

the outer shell may further include a click portion which accommodates the beveled edge that projects out from the rotatable plug.

With this, it is possible to arrest rotation of the rotatable plug with a click sensation provided by the click portion even at positions other than the unlocked position and the locked position. As such, application of the cylinder lock in a mode change switch is possible.

Moreover, the rotation arresting member may include a key hole which accommodates the key, and the key hole and the keyway may be positioned to overlap each other.

With this, since the rotation arresting member can be positioned to overlap with the keyway, there is no need to arrange the rotation arresting member so as to circumvent the keyway. This makes it possible to achieve miniaturization of the cylinder lock.

Moreover, the rotatable plug may include a plurality of the rotation arresting members, and at least one of the rotation arresting members may be provided with the beveled edge.

This makes it possible to improve the security of the lock.

Moreover, an electronic device may include: an outer shell provided with a cylindrical hollow portion therein; a rotatable plug rotatably positioned in the hollow portion of the outer shell and provided with a keyway along a rotational axis of the rotatable plug, the keyway being for accommodating a key; a rotation arresting member which arrests rotation of the rotatable plug by projecting out from the rotatable plug and entering a pathway provided in the outer shell; a biasing member which biases the rotation arresting member in a direction in which the rotation arresting member projects out from the rotatable plug; and a beveled edge provided at an end of the rotation arresting member and having a beveled surface which intersects a rotational direction of the rotatable plug, wherein insertion of the key into the keyway causes the beveled edge, along with the rotation arresting member, to move in a direction from the outer shell toward the rotatable plug to a position at which the beveled edge and an inner circumference of the outer shell intersect.

With this, it is possible to increase the security of the electronic device by equipping the electronic device with such a mechanical cylinder lock, and since a miniaturized, light-weight cylinder lock can be realized, this contributes to the miniaturization and weight reduction of portable electronic devices, for example.

Moreover, a cash register may include: an outer shell provided with a cylindrical hollow portion therein; a rotatable plug rotatably positioned in the hollow portion of the outer shell and provided with a keyway along a rotational axis of the rotatable plug, the keyway being for accommodating a key; a rotation arresting member which arrests rotation of the rotatable plug by projecting out from the rotatable plug and entering a pathway provided in the outer shell; a biasing member which biases the rotation arresting member in a direction in which the rotation arresting member projects out from the rotatable plug; and a beveled edge provided at an end of the rotation arresting member and having a beveled surface which intersects a rotational direction of the rotatable plug, wherein insertion of the key into the keyway causes the beveled edge, along with the rotation arresting member, to move in a direction from the outer shell toward the rotatable plug to a position at which the beveled edge and an inner circumference of the outer shell intersect.

With this, it is possible to increase the security of a cash register by equipping the cash register with such a mechanical cylinder lock.

### Advantageous Effects

The present invention makes it possible to provide a small, light-weight cylinder lock having few parts.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a schematic perspective view showing the appearance of the cylinder lock.

FIG. 2 is a schematic perspective view showing the appearance of the rotatable plug.

FIG. 3 is a schematic perspective view showing a cross-section of the cylinder lock in the x-y plane while the key is not inserted in the cylinder lock and the rotation arresting member is in a projected state.

FIG. 4 is a schematic perspective view showing a cross-section of the cylinder lock in the x-y plane while a key is inserted in the cylinder lock and the rotation arresting member is in a recessed state.

FIG. 5 is a perspective view of the rotation arresting member.

FIG. 6 is a cross-section for illustrating the operation of the rotation arresting member and the operation of the rotatable plug with respect to the outer shell.

FIG. 7 is a cross-section for illustrating the operation of the rotation arresting member and the operation of the rotatable plug with respect to the outer shell.

FIG. 8 is a cross-section for illustrating the operation of the rotation arresting member and the operation of the rotatable plug with respect to the outer shell.

FIG. 9 is a cross-section for illustrating the operation of the rotation arresting member and the operation of the rotatable plug with respect to the outer shell.

FIG. 10 a schematic perspective view showing a cross-section in the x-y plane of the cylinder lock provided with a click portion in the outer shell while a key is inserted in the cylinder lock and the rotation arresting member is in a recessed state.

FIG. 11 is a perspective view of the rotatable plug of the cylinder lock provided with a plurality of the rotation arresting members, and a key.

FIG. 12 is schematic perspective view showing an example of the appearance of the cash register.

FIG. 13 is a schematic perspective view showing a cross-section of a different aspect of the cylinder lock in the x-y plane.

### DESCRIPTION OF EMBODIMENTS

Next, embodiments of the cylinder lock according to the present invention will be discussed with reference to the Drawings. It should be noted that the following embodiments are merely examples of the cylinder lock according to the present invention. As such, the scope of the present invention is demarcated by the scope of the language in the Claims using the below embodiments as a reference, and is not intended to be limited merely by the following embodiments. Therefore, among the structural elements in the following exemplary embodiments, structural elements not recited in any one of the independent claims defining the most generic part of the inventive concept are described as preferred structural elements, and are not absolutely necessary to overcome the problem according to the present invention.

### Embodiment 1

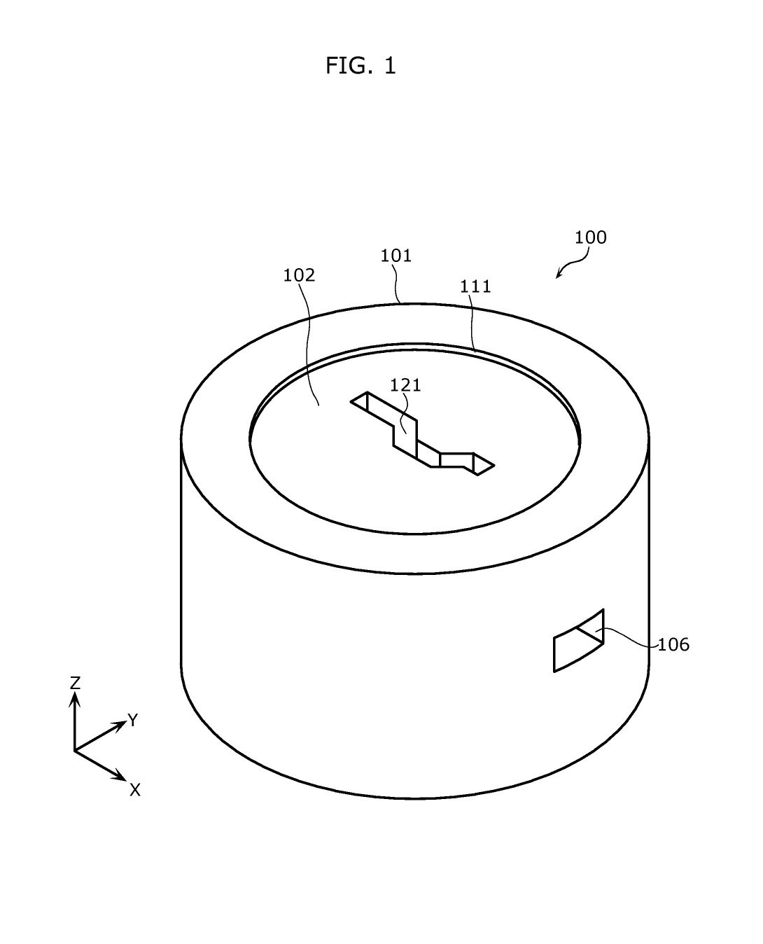

FIG. 1 is a schematic perspective view showing the appearance of the cylinder lock.

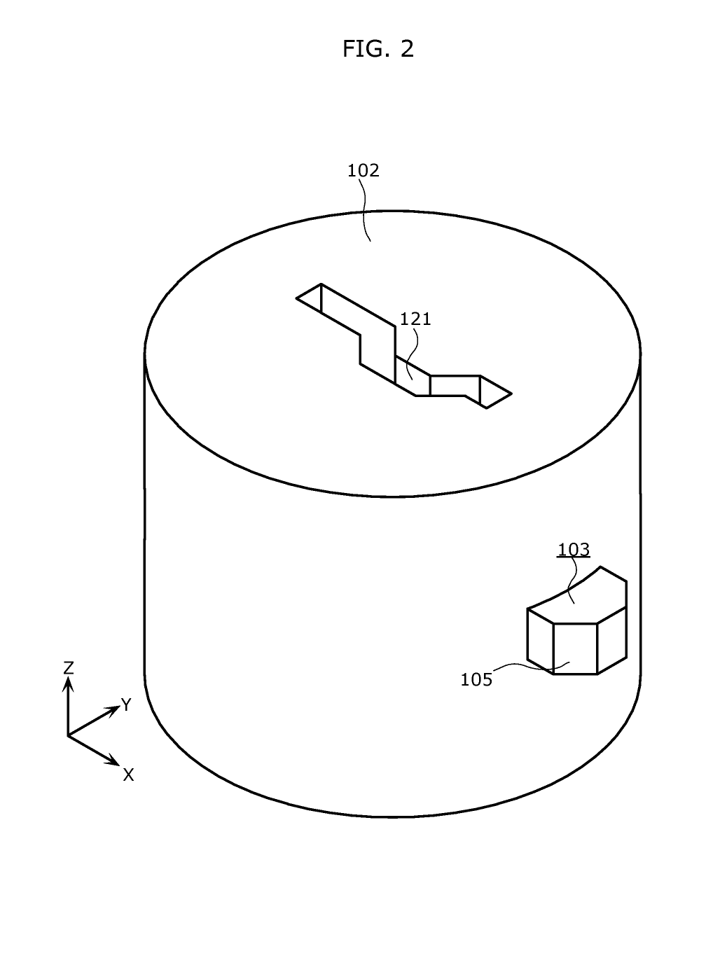

FIG. 2 is a schematic perspective view showing the appearance of the rotatable plug.

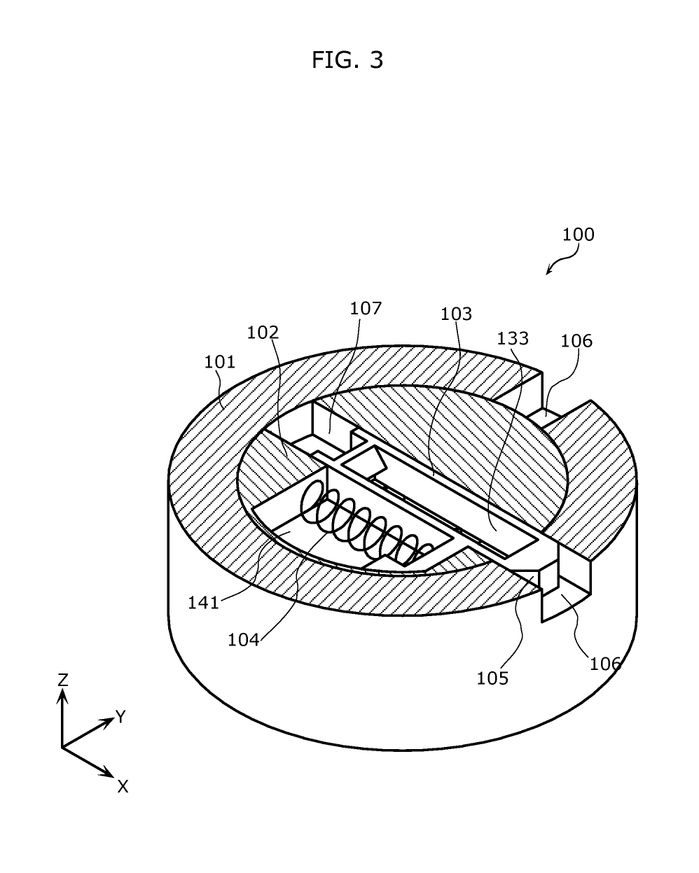

FIG. 3 is a schematic perspective view showing a cross-section of the cylinder lock in the x-y plane while the key is not inserted in the cylinder lock and the rotation arresting member is in a projected state.

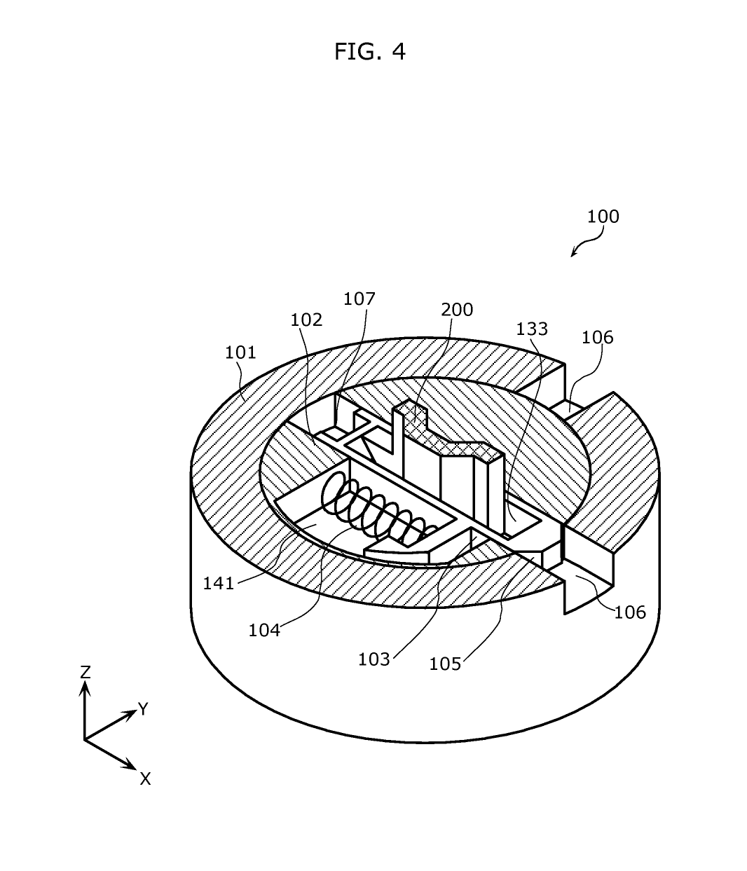

FIG. 4 is a schematic perspective view showing a cross-section of the cylinder lock in the x-y plane while a key is inserted in the cylinder lock and the rotation arresting member is in a recessed state.

As FIG. 1, FIG. 2, FIG.3, and FIG. 4 show, the cylinder lock 100 includes an outer shell 101, a rotatable plug 102, a rotation arresting member 103, a biasing member 104, a beveled edge 105, and a pathway 106.

The outer shell 101 has a cylindrical hollow portion therein for accommodating the rotatable plug 102. In Embodiment 1, the outer shell 101 is a cylindrical member having an internal cylindrical hollow portion. Moreover, the outer shell 101 includes a flange 111 which prevents the housed rotatable plug 102 from sliding out in the extraction direction of a key 200 (positive direction on the z axis in FIG. 1). The flange 111 is provided completely around the outer shell 101 projecting inward from the inner circumference edge of the outer shell 101.

The rotatable plug 102 has a cylindrical external shape and is provided along the rotational axis of the keyway 121 for insertion of the key 200. The rotatable plug 102 is so positioned in the outer shell 101 as to be rotatable relative to the outer shell 101. The rotational axis of the rotatable plug 102 and the central axis of the cylindrical internal hollow portion of the outer shell 101 are arranged on the same axis. Furthermore, the rotatable plug 102 is rotatably held about the rotational axis coinciding with the central axis of the internal hollow portion of the outer shell 101.

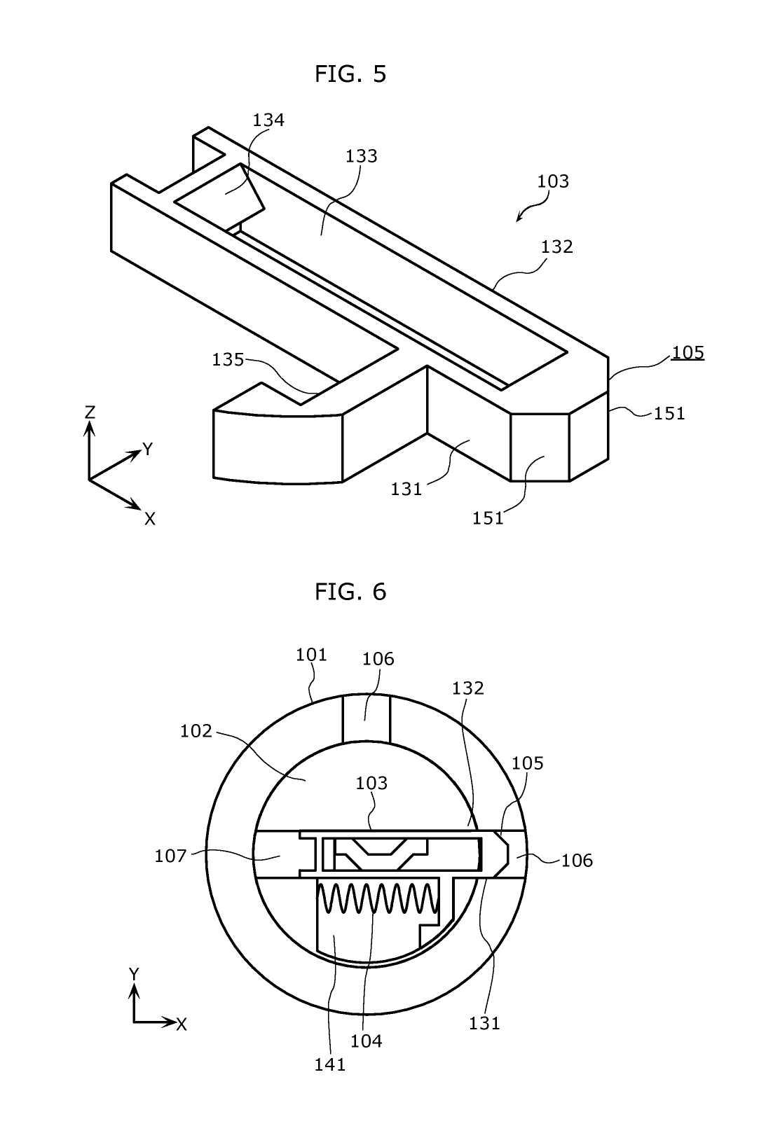

FIG. 5 is a perspective view of the rotation arresting member.

The rotation arresting member 103 is arranged to cross the boundary of the outer shell 101 and the rotatable plug 102 by projecting out from the rotatable plug 102 into the pathway 106 provided in the outer shell 101, thereby arresting rotation of the rotatable plug 102 with respect to the outer shell 101 (as FIG. 3 shows). In Embodiment 1, the rotation arresting member 103 is a member having a rectangular cross-section external shape located along a radial direction (x axis direction in the drawings) centered on the rotational axis and provided with a first surface 131 and a second surface 132 opposite the first surface 131 which, when the rotation arresting member 103 is projected out from the rotatable plug 102, intersect the plane of the boundary of the outer shell 101 and the rotatable plug 102. The rotation arresting member 103 is positioned to be extendible in the radial direction (x axis direction in the drawings) and move in a rotation arresting member housing area 107 of the rotatable plug 102 in the radial direction (x axis direction in the drawings). The first surface 131 or the second surface 132 is pushed against the outer shell 101 and rotation of the rotatable plug 102 is arrested by the rotation arresting member 103 being positioned to intersect the boundary between the outer shell 101 and the rotatable plug 102.

Moreover, in Embodiment 1, the rotation arresting member 103 includes a key hole 133 which accommodates the key 200. The key hole 133 is positioned to overlap the keyway. In other words, the key hole 133 is arranged in a positioned such that the key inserted in the keyway 121 is also inserted in the key hole 133. The key hole 133 is of a size which allows for movement of the rotation arresting member 103, which moves in the radial direction (x axis direction in the drawings), in the negative x axis direction shown in FIG. 4 while the key 200 is inserted (as FIG. 4 shows).

Moreover, the rotation arresting member 103 recedes in the rotatable plug 102 as a result of the key 200 being inserted in the keyway 121. More specifically, the rotation arresting member 103 recedes from a state in which the rotation arresting member 103 is projecting out (as FIG. 3 shows), to a state in which the beveled edge 105 intersects the inner circumference of the outer shell 101 (as FIG. 4 shows). In Embodiment 1, the rotation arresting member 103 is provided with an abutting surface portion 134 at an end opposite the beveled edge 105. The abutting surface portion 134 abuts a key inserted into the keyway 121.

The rotation arresting member 103 includes an engaging portion 135 which protrudes from the first surface 131 and extends in a direction (y axis direction in the drawings) which intersects the moving direction (x axis direction in the drawings) of the rotation arresting member 103. The engaging portion 135 is connected to the biasing member 104 and receives the biasing force from the biasing member 104.

The biasing member 104 biases the rotation arresting member 103 in the radial direction. In Embodiment 1, the biasing member 104 is a spring positioned in a biasing member positioning space 141 formed between the engaging portion 135 of the rotation arresting member 103 and the rotatable plug 102. The biasing member 104 is positioned so as to bias the rotation arresting member 103 in a direction from the rotatable plug 102 toward the outer shell 101.

It should be noted that the biasing member 104 may directly bias the rotation arresting member 103 without the use of the engaging portion 135. Moreover, for example, a compression spring, pulling spring, plate spring, resin spring, or an elastic material such as rubber may be used as the biasing member 104.

The beveled edge 105 is provided at the end of the rotation arresting member 103 near the outer shell 101. The beveled edge 105 aligns in a position intersecting the inner circumference of the outer shell 101 as a result of a key being inserted in the keyway 121 and thereby moving the rotation arresting member 103 into the rotatable plug 102. The beveled edge 105 includes a beveled surface 151 which intersects the rotational direction of the rotatable plug 102. The beveled surface 151 is pressed against the outer shell 101 as a result of the key 200 being inserted and the rotatable plug 102 being rotated relative to the outer shell 101. With the above configuration, the rotation arresting member 103 recedes into the rotatable plug 102 against the biasing force of the biasing member 104 as a result of the rotatable plug 102 being turned by the inserted key 200. It should be noted that the beveled surface 151 is not limited to a flat surface, and may be a curved surface.

The pathway 106 is provided at the inner periphery of the outer shell 101, and is of a size that can accommodate a portion of the rotation arresting member 103. In Embodiment 1, the pathway 106 accommodates the beveled edge 105, and furthermore, is of a size that can accommodate a portion of the rotation arresting member 103. The pathway 106 is provided penetrating the outer shell 101 in the radial direction. Configuring the pathway 106 which penetrates the outer shell 101 in this way simplifies the formation of the outer shell 101.

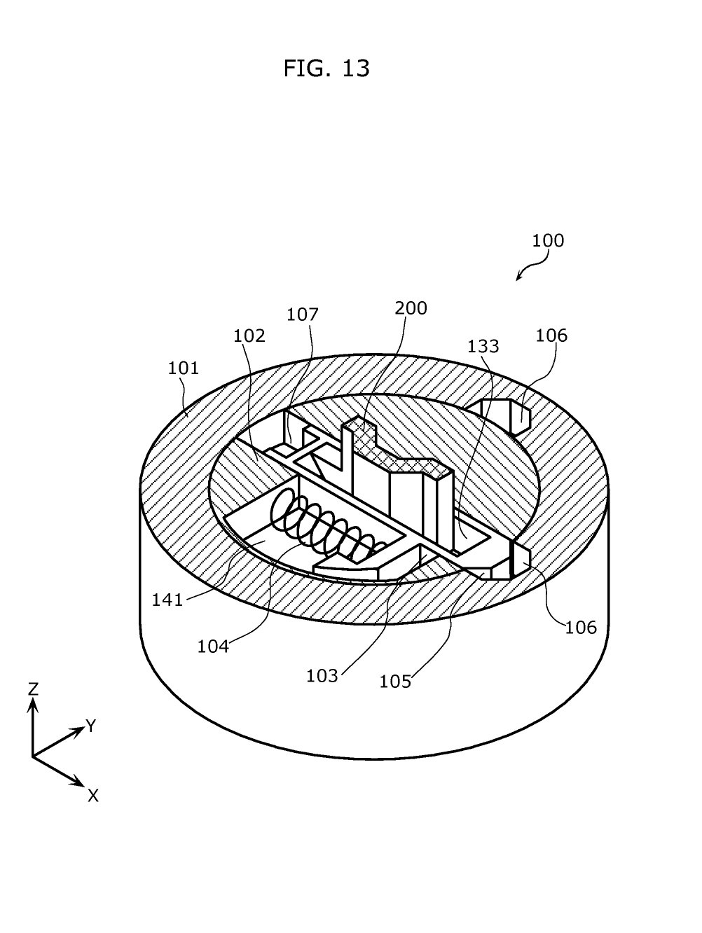

It should be noted that in the drawings, the pathway 106 is illustrated as a through hole which penetrates the outer shell 101, but the pathway 106 may be a hole with one end closed, as is shown in FIG. 13.

The rotation arresting member housing area 107 is provided in the rotatable plug 102 and is capable of accommodating the rotation arresting member 103. It should be noted that in Embodiment 1, the rotation arresting member housing area 107 penetrates through the rotatable plug 102, but this example is not intended to be limiting. For example, one end of the rotation arresting member housing area 107 may be closed.

Next, operation of the cylinder lock 100 according to Embodiment 1 will be described.

First, as FIG. 3 and FIG. 6 show, when the key 200 is not inserted in the keyway 121, the rotation arresting member 103 is positioned in the pathway 106 and the first surface 131 and the second surface 132 intersect the boundary of the outer shell 101 and the rotatable plug 102. In other words, the beveled edge 105 penetrates the pathway 106 provided in the outer shell 101 in its entirety. In this state, even if one attempts to do so, the rotatable plug 102 cannot be rotated relative to the outer shell 101 since the first surface 131 or the second surface 132 of the rotation arresting member 103 will push against the outer shell 101. In other words, the cylinder lock 100 is in a locked state.

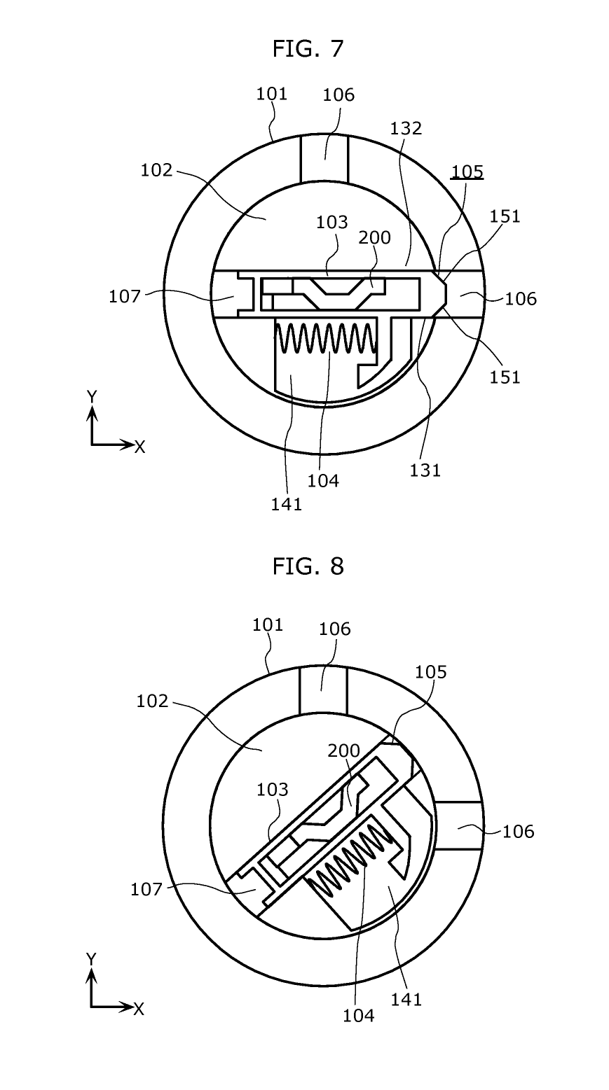

Next, as FIG. 4 and FIG. 7 show, the key 200 abuts the abutting surface portion 134 of the rotation arresting member 103 as a result of being inserted in the keyway 121, and the rotation arresting member 103 moves into the rotatable plug 102 to a position at which the beveled edge 105 intersects the inner circumference of the outer shell 101.

Next, when the operator turns the key 200, the rotation arresting member 103 rotates about the center of the rotating axis along with the rotation of the rotatable plug 102. In the first stage of this rotation, the beveled surface 151 of the beveled edge 105 pushes against the outer shell 101, and the rotation arresting member 103 moves into the rotatable plug 102 until the beveled edge 105 is housed in the rotation arresting member housing area 107 of the rotatable plug 102, as is shown in FIG. 8. In this stage, the click sensation generated as the portion of the beveled edge 105 pushed against the outer shell 101 by the biasing member 104 transitions from the beveled surface 151 to the tip surface is perceived by the operator.

The rotatable plug 102 rotates smoothly while the rotation arresting member 103 including the beveled edge 105 is housed in the rotation arresting member housing area 107, like in the state shown in FIG. 8

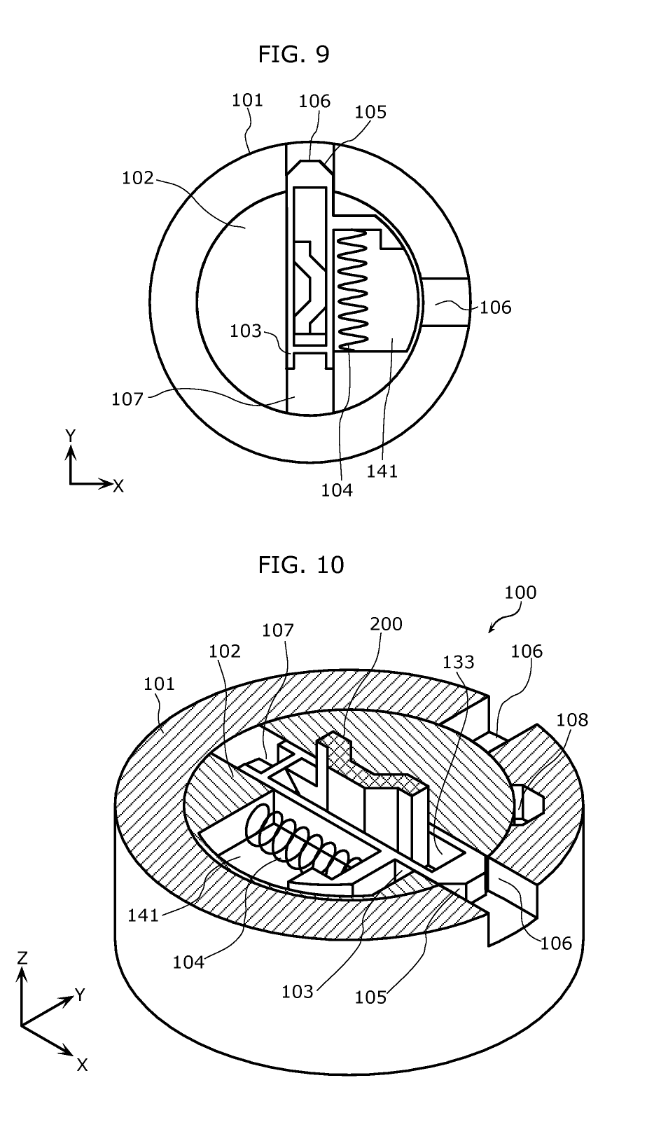

Next, when the rotatable plug 102 is turned further, the biasing force of the biasing member 104 forces the rotation arresting member 103 to enter a second pathway 106, as FIG. 9 shows. During this stage, the click sensation as the portion of the beveled edge 105 pushed against the outer shell 101 by the biasing member 104 transitions from the tip surface to the beveled surface 151 and from the beveled surface 151 to the first surface 131 or the second surface 132 is perceived by the operator operating the key 200. In Embodiment 1, since the abutting surface portion 134 collides with the key 200, there are instances in which this collision is perceived as a click sensation as well.

By repeating the above-described operations, the cylinder lock 100 according to Embodiment 1 can provide a click sensation while performing unlocking and locking operations. Moreover, since the rotation arresting member 103 which arrests the rotation of the rotatable plug 102 also functions to generate a click sensation, it is possible to reduce the number of parts of the cylinder lock 100 and achieve a small, light-weight cylinder lock 100.

It should be noted that the above cylinder lock 100 may be structured like is shown in FIG. 10. In other words, in addition to the above cylinder lock 100, the outer shell 101 may include a click portion 108 which is a space that accommodates the beveled edge 105 which projects out from the rotatable plug 102.

In Embodiment 1, the click portion 108 generates a click sensation upon the beveled edge 105 entering therein, but the click portion 108 is of a size that holds the beveled edge 105 at a position which intersects the inner circumference of the outer shell 101. Moreover, similar to the pathway 106, the click portion 108 may be a through-hole which penetrates the outer shell 101.

With the above configuration, when the key 200 is inserted in the rotatable plug 102 and the rotatable plug 102 is turned, the biasing force of the biasing member 104 forces the rotation arresting member 103 to enter the click portion 108. At this time, change in the position of the beveled edge 105 being pushed against the outer shell 101 by the biasing member 104 generates a click sensation. However, in this case, since the first surface 131 and second surface 132 of the rotation arresting member 103 are not positioned crossing the boundary between the outer shell 101 and the rotatable plug 102, turning of the rotatable plug 102 can be continued.

As such, it is possible to provide the cylinder lock 100 with a position which generates a click sensation in a position other than the unlocked position or the locked position, and it is possible provide the cylinder lock 100 with functions other than locking and unlocking functions.

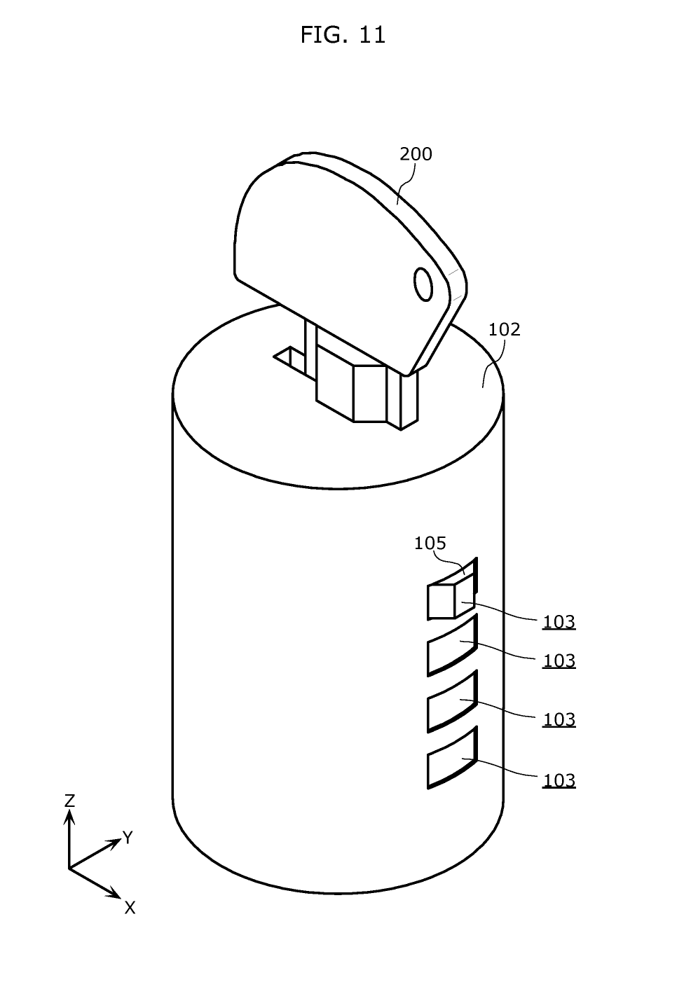

Moreover, the above cylinder lock 100 may include a plurality of the rotation arresting members 103, as FIG. 11 shows. Moreover, among the plurality of rotation arresting members 103, at least one of the rotation arresting members 103 may be provided with a beveled edge 105 at the tip end thereof, and all other rotation arresting members 103 not provided with the beveled edge 105 may enter inside the rotatable plug 102 as a result of the key 200 being inserted.

In this case, the number of the above pathways 106 provided in the outer shell 101 corresponds to the number of rotation arresting members 103.

With the cylinder lock 100 having above configuration, a click sensation can be generated by the rotation arresting member 103 while also improving the security of the cylinder lock 100.

It should be noted that in FIG. 11, one of the rotation arresting members 103 is provided with the beveled edge 105, but any given number or all of the rotation arresting members 103 may be provided with the beveled edge 105.

### Embodiment 2

Next, an embodiment of the electronic device (cash register inclusive) according to the present invention will be discussed with reference to the Drawings. It should be noted that the following embodiment is merely an example of the electronic device (cash register inclusive) according to the present invention. As such, the scope of the present invention is demarcated by the scope of the language in the Claims using the below embodiments as a reference, and is not intended to be limited merely by the following embodiments.

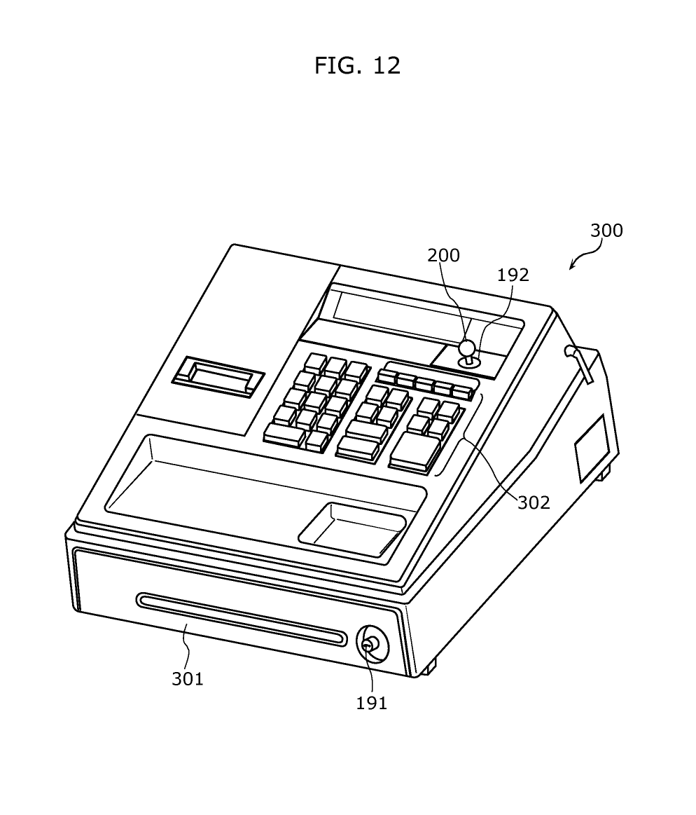

FIG. 12 is an external perspective view schematically depicting an example of the cash register.

As FIG. 12 shows, the cash register 300 is provided with the cylinder lock 100 as a first lock 191. The cylinder lock 100 includes the outer shell 101 provided with the pathway 106, the rotatable plug 102 provided with the rotation arresting member housing area 107 and the keyway 121, the rotation arresting member 103 which moves into the rotatable plug 102 by the key 200 being inserted, the biasing member 104 which biases the rotation arresting member 103 in a projecting direction from the rotatable plug 102, and the beveled edge 105 provided with the beveled surface 151 at the tip end of the rotation arresting member 103 for generating a click sensation.

The first lock 191 is attached to a drawer 301 used for holding cash, and is used for locking and unlocking the drawer 301. The key 200 is insertable into and removable from the first lock 191 when the first lock 191 is in a locked state as well as when the first lock 191 is in an unlocked state.

Furthermore, in Embodiment 2, the cash register 300 also includes the cylinder lock 100 as a second lock 192. In addition to the configuration of the first lock 191 (the configuration of the cylinder lock 100 according to Embodiment 1), the second lock 192 includes, in the outer shell 101, the click portion 108 which is a space that accommodates the beveled edge 105 which projects out from the rotatable plug 102.

The second lock 192 is attached above an array of keys 302 of the cash register 300, and is used to switch between modes of the cash register 300. More specifically, in the cash register 300, the second lock 192 can be unlocked by inserting the key in the second lock 192 after the key 200 is inserted in the first lock 191 and the first lock 191 is unlocked. In other words, the first lock 191 and the second lock 192 use the same key 200. Then, going by the click sensation from the key 200 inserted in the second lock 192 and the symbols and/or characters displayed on the screen of the cash register 300 (not shown in the Drawings), the operator turns the key 200 to select a desired mode. More specifically, for example, symbols and/or characters which correspond to the position of the pathway 106 included in the outer shell 101 or the position of the click portion 108 like shown in FIG. 10 are displayed on the screen of the cash register 300. The operator turns the key 200 while watching the symbols and/or characters indicating the desired mode, and stops turning the key using the click sensation when the beveled edge 105 enters the pathway 106 or the click portion 108 as a guide.

With this, even if the rotation position of the rotatable plug 102 is stopped at a position other than the unlocked position or the locked position, it is possible to accurately turn ON or OFF an electrical contact (not shown in the Drawings) which operates together with the rotation of the rotatable plug 102, and operate a desired mode of the cash register 300.

It is to be noted that the present invention is not limited to the above exemplary embodiments. For example, those skilled in the art will readily appreciate that many modifications are possible in the exemplary embodiments without materially departing from the novel teachings and advantages of the present invention. Accordingly, all such modifications are intended to be included within the scope of the present invention.

For example, the number of pathways 106, rotation arresting member housing areas 107, and click portions 108 used is not limited to a certain number, and, for example, may correspond to the number of modes required for the electronic device (cash register inclusive) equipped with the cylinder lock 100.

Moreover, the outer shell 101 may be structurally combined with the housing of the electronic device, such as the cash register.

Moreover, hereinbefore, the biasing member 104 is exemplified as a coil spring, but the biasing member 104 may, for example, be a different kind of spring such as a leaf spring. Moreover, the material of the biasing member 104 is not limited to metal or resin.

Moreover, a cash register may include (i) a first lock including: an outer shell provided with a cylindrical hollow portion therein; a rotatable plug rotatably positioned in the hollow portion of the outer shell and provided with a keyway along a rotational axis of the rotatable plug, the keyway being for accommodating a key; a rotation arresting member which arrests rotation of the rotatable plug by projecting out from the rotatable plug and entering a pathway provided in the outer shell; a biasing member which biases the rotation arresting member in a direction in which the rotation arresting member projects out from the rotatable plug; and a beveled edge provided at an end of the rotation arresting member and having a beveled surface which intersects a rotational direction of the rotatable plug, wherein insertion of the key into the keyway causes the beveled edge, along with the rotation arresting member, to move in a direction from the outer shell toward the rotatable plug to a position at which the beveled edge and an inner circumference of the outer shell intersect, and (ii) a second lock having a configuration of the first lock and additionally including, in the outer shell, a click portion which accommodates the beveled edge which moves, along with the rotation arresting member, in a direction from the outer shell toward the rotatable plug, the click portion holding the beveled edge at a position at which the beveled edge and an inner circumference of the outer shell intersect.

With this, a common key can be used for unlocking and locking the drawer which holds cash and for changing the mode of the cash register, which makes it possible to provide a more convenient cash register.

### INDUSTRIAL APPLICABILITY

The present invention can be used in locks for lockers or desks, electronic devices such as cash registers, information terminals, and cellular phones for security purposes and/or switching modes.

1. A cylinder lock comprising:
an outer shell provided with a cylindrical hollow portion therein;
a rotatable plug rotatably positioned in the hollow portion of the outer shell and provided with a keyway along a rotational axis of the rotatable plug, the keyway being for accommodating a key;
a rotation arresting member which arrests rotation of the rotatable plug by projecting out from the rotatable plug and entering a pathway provided in the outer shell;
a biasing member which biases the rotation arresting member in a direction in which the rotation arresting member projects out from the rotatable plug; and
a beveled edge provided at an end of the rotation arresting member and having a beveled surface which intersects a rotational direction of the rotatable plug,
wherein insertion of the key into the keyway causes the beveled edge, along with the rotation arresting member, to move in a direction from the outer shell toward the rotatable plug to a position at which the beveled edge and an inner circumference of the outer shell intersect.

2. The cylinder lock according to claim 1,
wherein the outer shell further includes a click portion which accommodates the beveled edge that projects out from the rotatable plug.

3. The cylinder lock according to claim 1,
wherein the rotation arresting member includes a key hole which accommodates the key, and
the key hole and the keyway are positioned to overlap each other.

4. The cylinder lock according to claim 2,
wherein the rotation arresting member includes a key hole which accommodates the key, and
the key hole and the keyway are positioned to overlap each other.

5. The cylinder lock according to claim 1,
wherein the rotatable plug includes a plurality of the rotation arresting members, and
at least one of the rotation arresting members is provided with the beveled edge.

6. The cylinder lock according to claim 2,
wherein the rotatable plug includes a plurality of the rotation arresting members, and
at least one of the rotation arresting members is provided with the beveled edge.

7. The cylinder lock according to claim 3,
wherein the rotatable plug includes a plurality of the rotation arresting members, and
at least one of the rotation arresting members is provided with the beveled edge.

8. An electronic device comprising:
an outer shell provided with a cylindrical hollow portion therein;
a rotatable plug rotatably positioned in the hollow portion of the outer shell and provided with a keyway along a rotational axis of the rotatable plug, the keyway being for accommodating a key;
a rotation arresting member which arrests rotation of the rotatable plug by projecting out from the rotatable plug and entering a pathway provided in the outer shell;
a biasing member which biases the rotation arresting member in a direction in which the rotation arresting member projects out from the rotatable plug; and
a beveled edge provided at an end of the rotation arresting member and having a beveled surface which intersects a rotational direction of the rotatable plug,
wherein insertion of the key into the keyway causes the beveled edge, along with the rotation arresting member, to move in a direction from the outer shell toward the rotatable plug to a position at which the beveled edge and an inner circumference of the outer shell intersect.

9. A cash register comprising:
an outer shell provided with a cylindrical hollow portion therein;
a rotatable plug rotatably positioned in the hollow portion of the outer shell and provided with a keyway along a rotational axis of the rotatable plug, the keyway being for accommodating a key;
a rotation arresting member which arrests rotation of the rotatable plug by projecting out from the rotatable plug and entering a pathway provided in the outer shell;
a biasing member which biases the rotation arresting member in a direction in which the rotation arresting member projects out from the rotatable plug; and
a beveled edge provided at an end of the rotation arresting member and having a beveled surface which intersects a rotational direction of the rotatable plug,
wherein insertion of the key into the keyway causes the beveled edge, along with the rotation arresting member, to move in a direction from the outer shell toward the rotatable plug to a position at which the beveled edge and an inner circumference of the outer shell intersect.
